(19) United States
(12) Patent Application Publication
(10) Pub. No.: US 2015/0167621 A1
(43) Pub. Date: Jun. 18, 2015

(54) METHOD OF CONTROLLING STARTUP OF VEHICLE

(71) Applicants: Hyundai Motor Company, Seoul (KR); Kia Motors Corp., Seoul (KR)

(72) Inventor: Do Sun CHOI, Yongin-si (KR)

(73) Assignees: Hyundai Motor Company, Seoul (KR); Kia Motors Corp., Seoul (KR)

(21) Appl. No.: 14/455,536

(22) Filed: Aug. 8, 2014

(30) Foreign Application Priority Data
Dec. 17, 2013 (KR) 10-2013-0157640

(51) Int. Cl. F02N 19/00; F02D 41/22

(52) U.S. Cl. CPC F02N 19/001; F02D 41/22; F02D 2041/224

(57) ABSTRACT

A method of controlling startup of a vehicle may include a key-on/off determination step of determining whether a key is on or off; and a removal step of removing icing generated in an injector for fuel injection by forcibly operating the injector predetermined times for a predetermined time period when it is determined that the key is on.

### CROSS-REFERENCE(S) TO RELATED APPLICATION

The present application claims priority of Korean Patent Application Number 10-2013-0157640 filed on Dec. 17, 2013, the entire contents of which is incorporated herein for all purposes by this reference.

### BACKGROUND OF THE INVENTION

1. Field of the Invention

The present invention relates generally to a method of controlling the startup of a vehicle and, more particularly, to a method of controlling the startup of a vehicle, which is capable of improving startability via logic for forcibly removing icing in a key-on condition prior to startup and of improving startability via logic for preventing icing in a key-off condition.

2. Description of Related Art

When a multi-point injection (MPI) system is applied to a commercialized natural gas engine for a vehicle, it is necessary that constant pressure be maintained in a fuel rail.

The volume of gas fuel is expanded because the temperature of the gas fuel rises under the influence of a heat exchanger for always supplying the gas fuel at constant temperature when an engine is stopped after being driven. The expanded gas fuel influences parts that prevent leakage in an injector and a gas shut-off valve, which makes subsequent startup difficult.

Furthermore, after the engine of the vehicle has been stopped, moisture is generated in the pintle part of the injector and the gas shutoff valve due to a low temperature condition and humidity in a surrounding environment. In this case, a problem may arise in that there occurs an icing phenomenon in which moisture and the remaining fuel in the injector part are frozen due to the surrounding low temperature environment.

In particular, such an icing phenomenon interrupts the supply of fuel through the injector, which leads to customers' complaints against poor low-temperature startability.

Korean Patent Application Publication No. 10-2005-0003082 discloses an apparatus for preventing icing in an injector for an LPI engine.

This conventional method is problematic in that the cost and weight of a vehicle increase because the additional installation of the apparatus for preventing icing is required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of controlling the startup of a vehicle, which is capable of improving startability upon cold startup via logic for forcibly removing icing in a key-on condition prior to startup, to providing a method of controlling the startup of a vehicle, which is capable of improving startability upon cold startup via logic for preventing icing in a key-off condition.

In an aspect of the present invention, a method of controlling startup of a vehicle, may include a key-on/off determination step of determining whether a key is on or off, and a removal step of removing icing generated in an injector for fuel injection by forcibly operating the injector predetermined times for a predetermined time period when it is determined that the key is on.

The removal step is configured such that the injector is forcibly operated by applying a predetermined Pulse Width Modulation (PWM) signal to the injector.

An operating time of the injector, a number of times that the injector is operated, and an opening cycle of the injector are set via the PWM signal, and the injector is forcibly operated based on the set values.

The removal step is performed once.

The method may further include after the removal step, an icing determination step of determining whether or not the icing may have been removed by comparing a pressure in a fuel line with a reference pressure and removing the icing again when it is determined that the icing may have not been removed.

The icing determination step may include a shutoff step of shutting off inflow of fuel into the injector when it is determined prior to the removal step that the key is on, an inflow step of, after the removal step, making fuel flow into the injector in a state in which the injector may have been closed, a delivery step of opening and operating the injector and then delivering the fuel, and a repetitive removal step of reentering the shutoff step when the pressure in the fuel line is equal to or lower than a first reference pressure and then removing the icing.

Between the inflow step and the delivery step a measurement step of measuring the pressure in the fuel line, and a detection step of detecting a phenomenon in which fuel of the injector leaks when the pressure in the fuel line is equal to or lower than a second reference pressure.

The inflow and shutoff of the fuel at the shutoff step and the inflow step are performed by opening or closing a low-pressure regulator.

The method may further include a purging step of, when it is determined that the key is off, purging remaining fuel within a fuel line so that a fuel pressure in the fuel line is maintained at a target pressure by forcibly opening and operating the injector.

The purging step is configured such that the injector is forcibly operated by applying a predetermined PWM signal to the injector.

An operating time of the injector and an opening time of the injector for purging are set via the PWM signal, and the injector is forcibly operated based on the set values.

The method may further include, after the purging step a measurement step of measuring the pressure in the fuel line, and a repetitive purging step of reentering the purging step when the pressure in the fuel line exceeds the target pressure and purging remaining fuel within the fuel line.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a control flow when a key is on in a method of controlling the startup of a vehicle according to an exemplary embodiment of the present invention.

FIG. 2 is a diagram illustrating a control flow when a key is off in a method of controlling the startup of a vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Reference now should be made to the drawings, in which the same reference numerals are used throughout the different drawings to designate the same or similar components.

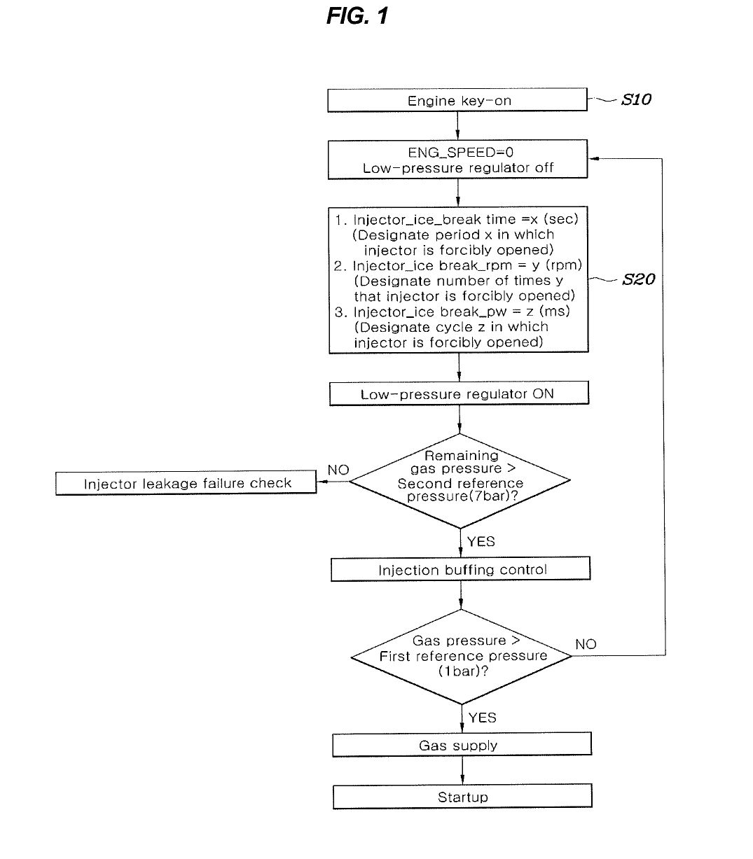

FIG. 1 is a diagram illustrating a control flow when a key is on in a method of controlling the startup of a vehicle according to an exemplary embodiment of the present invention.

The method of controlling the startup of a vehicle according to an exemplary embodiment of the present invention basically includes a key-on/off determination step S10 and a removal step S20.

More specifically, referring to FIG. 1, the method of controlling the startup of a vehicle is configured to include the key-on/off determination step S10 of determining whether a key is on or off and the removal step S20 of removing icing in an injector for fuel injection by forcibly operating the injector for a predetermined time several times when it is determined that the key is on.

That is, when the key is on prior to the startup of the vehicle, the injector is forcibly and rapidly operated for a predetermined time, and thus the injector is repeatedly opened and closed as it vibrates along a straight-line displacement. Accordingly, icing in the periphery of the injector and a gas shut-off valve is removed by the vibration action attributable to the operation of the injector. As a result, the startability of a vehicle using gas as fuel can be significantly improved because a low-temperature startup time is considerably reduced when startup is performed after the key is on.

At the removal step S20 of the present invention, the injector may be forcibly operated by applying a specific Pulse Width Modulation (PWM) signal to the injector.

More specifically, referring to FIG. 1, the operating time of the injector, the opening time of the injector, the number of times that the injector is operated, and the opening cycle of the injector may be set via the PWM signal, and the injector may be forcibly operated based on the set values.

That is, a high PWM signal is rapidly applied to the injector during a controllable time, thereby enabling the operation of the injector to be smoothly performed.

In an exemplary embodiment of the present invention, the removal step S20 may be controlled so that it is performed only once.

That is, when the injector is operated, a phenomenon in which a large amount of fuel is made to flow into a combustion chamber may occur. When the key is on prior to startup, the removal step S20 may be controlled so that it is performed only once regardless of whether or not icing has been removed.

The present invention may further include, after the removal step S20, an icing determination step of determining whether or not icing has been removed by comparing the pressure in a fuel line with a reference pressure and removing icing again when it is determined that icing has not been removed.

The icing determination step may be configured to include a shutoff step, an inflow step, a delivery step, and a repetitive removal step.

More specifically, the icing determination step may be configured to include the shutoff step of shutting off the inflow of fuel into the injector when it is determined prior to the removal step S20 that the key is on, the inflow step of making fuel flow into the injector in the state in which the injector has been closed after the removal step S20, the delivery step of opening and then operating the injector and delivering fuel, and the repetitive removal step of entering the shutoff step again when the pressure in the fuel line is equal to or lower than a first reference pressure and then removing icing.

The inflow and shutoff of fuel at the shutoff step and the inflow step may be performed by the opening and closing operations of a low-pressure regulator.

That is, when the key is on, icing is removed at the removal step S20 in the state in which the low-pressure regulator has been closed. Thereafter, when the low-pressure regulator is opened in the state in which the injector has been closed, the injector is filled with fuel via the fuel line.

Thereafter, when the injector is opened, fuel is delivered through the fuel line and the injector. In this case, when the pressure in the fuel line is measured to be equal to or lower than a first reference pressure, it is determined that icing has been removed. The first reference pressure may be a minimum pressure for the startup of the vehicle. After it is determined that icing has been removed, control may be performed so that the injector is closed before startup. In this case, the pressure in the fuel line may be the pressure that is present between the injector and the low-pressure regulator.

In contrast, when the pressure in the fuel line exceeds the first reference pressure, it is determined that the pressure in the fuel line has not dropped because icing has not been removed. When it is determined that icing has not been removed, the logic enters the shutoff step prior to the removal step S20 and the operation of removing icing is performed again. Accordingly, the startability of a vehicle is improved by reliably removing icing.

The present invention may be configured to further include, between the inflow step and the delivery step, a measurement step of measuring the pressure in the fuel line, and a detection step of detecting a phenomenon in which the fuel of the injector leaks when the pressure in the fuel line is equal to or lower than a second reference pressure.

That is, when the low-pressure regulator is opened in the state in which the injector has been closed after the removal step S20, the injector is filled with fuel via the fuel line.

In this case, when the fuel pressure in the fuel line is measured to exceed the second reference pressure because the injector has been closed, it is determined that the injector is in a normal state. When the fuel pressure in the fuel line is measured to be equal to or lower than the second reference pressure, it is determined that a failure situation has occurred in which fuel leaked from the injector. When it is determined that a failure situation has occurred, control may be performed via a cluster so that a user is notified of the failure situation.

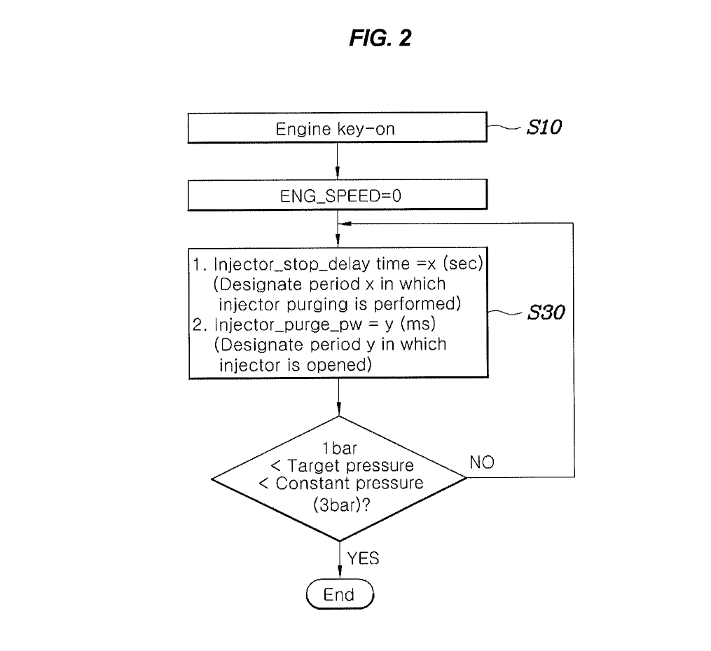

FIG. 2 is a diagram illustrating a control flow when the key is off in a method of controlling the startup of a vehicle according to an exemplary embodiment of the present invention.

Referring to FIG. 2, the method of controlling the startup of a vehicle according to an exemplary embodiment of the present invention may be configured to include a purging step S30 of purging the remaining fuel within the fuel line so that the fuel pressure in the fuel line is maintained at a target pressure by forcibly opening and operating the injector when it is determined that the key is off. In this case, when the key of the vehicle is off, the low-pressure regulator may be closed, and thus fuel may not be supplied to the injector.

That is, when the vehicle enters a key-off state in which the engine is stopped after being run, the injector is forcibly opened and operated so that the remaining fuel within the fuel line is purged. Accordingly, an icing phenomenon that occurs due to a low temperature environment can be prevented. Furthermore, the remaining fuel is purged to the extent that the pressure in the fuel line can be maintained at the target pressure. Accordingly, the startability of the vehicle can be improved.

The target pressure may be a pressure value in a specific pressure range.

At the purging step S30 of the present invention, the injector can be forcibly operated by applying a specific PWM signal to the injector.

More specifically, referring to FIG. 2, the operating time of the injector and the opening and operating time of the injector for purging may be set via the PWM signal, and the injector may be forcibly operated based on the set values.

That is, the injector is opened and operated by applying the PWM signal to the injector, thereby purging the remaining fuel in the state in which a specific fuel pressure is maintained within the fuel line.

The present invention may be configured to further include, after the purging step S30, a measurement step of measuring the pressure in the fuel line and a repetitive purging step of reentering the purging step S30 when the pressure in the fuel line exceeds the target pressure and then purging the remaining fuel within the fuel line.

That is, when the injector is forcibly opened and operated when the key is off, it is necessary that the remaining fuel within the fuel line be discharged and thus the fuel pressure in the fuel line reach a target pressure within the target pressure range. When the measured fuel pressure does not reach the target pressure, the logic reenters the purging step S30 at which the remaining fuel is purged. Accordingly, icing can be prevented, and startability can be improved.

As described above, in accordance with the present invention, when the key is on, the injector is forcibly and rapidly opened for a predetermined time, and thus icing generated near the injector can be removed by a vibration action attributable to the operation of the injector. Accordingly, the present invention is advantageous in that low-temperature startup time is considerably reduced upon cold startup and thus the startability of a vehicle can be significantly improved.

Furthermore, when the key is off, the injector is forcibly opened and operated for a predetermined time so that the remaining fuel is purged while a specific pressure is being maintained. Accordingly, the present invention is advantageous in that an icing phenomenon that occurs due to a low temperature environment after the key is off can be prevented and thus the startability of a vehicle can be improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling startup of a vehicle, comprising:
a key-on/off determination step of determining whether a key is on or off; and
a removal step of removing icing generated in an injector for fuel injection by forcibly operating the injector predetermined times for a predetermined time period when it is determined that the key is on.

2. The method of claim 1, wherein the removal step is configured such that the injector is forcibly operated by applying a predetermined Pulse Width Modulation (PWM) signal to the injector.

3. The method of claim 2, wherein an operating time of the injector, a number of times that the injector is operated, and an opening cycle of the injector are set via the PWM signal, and the injector is forcibly operated based on the set values.

4. The method of claim 1, wherein the removal step is performed once.

5. The method of claim 1, further comprising,
after the removal step, an icing determination step of determining whether or not the icing has been removed by comparing a pressure in a fuel line with a reference pressure and removing the icing again when it is determined that the icing has not been removed.

6. The method of claim 5, wherein the icing determination step comprises:
a shutoff step of shutting off inflow of fuel into the injector when it is determined prior to the removal step that the key is on;
an inflow step of, after the removal step, making fuel flow into the injector in a state in which the injector has been closed;
a delivery step of opening and operating the injector and then delivering the fuel; and
a repetitive removal step of reentering the shutoff step when the pressure in the fuel line is equal to or lower than a first reference pressure and then removing the icing.

7. The method of claim 6, further comprising, between the inflow step and the delivery step:
a measurement step of measuring the pressure in the fuel line; and
a detection step of detecting a phenomenon in which fuel of the injector leaks when the pressure in the fuel line is equal to or lower than a second reference pressure.

8. The method of claim 6, wherein the inflow and shutoff of the fuel at the shutoff step and the inflow step are performed by opening or closing a low-pressure regulator.

9. The method of claim 1, further comprising:
a purging step of, when it is determined that the key is off, purging remaining fuel within a fuel line so that a fuel pressure in the fuel line is maintained at a target pressure by forcibly opening and operating the injector.

10. The method of claim 9, wherein the purging step is configured such that the injector is forcibly operated by applying a predetermined PWM signal to the injector.

11. The method of claim 10, wherein an operating time of the injector and an opening time of the injector for purging are set via the PWM signal, and the injector are forcibly operated based on the set values.

12. The method of claim 9, further comprising, after the purging step:
a measurement step of measuring the pressure in the fuel line; and
a repetitive purging step of reentering the purging step when the pressure in the fuel line exceeds the target pressure and purging remaining fuel within the fuel line.
